(19) United States
(12) Patent Application Publication
(10) Pub. No.: US 2002/0190095 A1
(43) Pub. Date: Dec. 19, 2002

(54) Electro-resistance-welded tube squeeze roll unit

(76) Inventors: Takashi Kazama, Aizuywakamatsu-shi (JP); Kazunori Ozaki, Aizuwakamatsu-shi (JP)

Correspondence Address: HARNESS, DICKEY & PIERCE, P.L.C., P.O. BOX 828, BLOOMFIELD HILLS, MI, 48303, US

(21) Appl. No.: 10/167,151

(22) Filed: Jun. 11, 2002

(30) Foreign Application Priority Data
Jun. 13, 2001 (JP) 2001-178,931

(51) Int. Cl. B23K 1/20

(52) U.S. Cl. 228/17; 228/49.3

(57) ABSTRACT

A rotation shaft 34 of each squeeze roll 8 is rotatably supported by bearings 36a, 36b inside a through hole 35 formed in bearing boxes 23a, 23b. Tapered rolls 37 are provided in the bearings that support the rotation shaft 34. Side surfaces 28a, 29a of both wing portions of the bearing boxes are formed in a tapered configuration and these two side surfaces are fixed by being pressed by side plates 24a, 24b. A spacer 32 is provided between an upper wide diameter portion 34a and each squeeze roll 8 for adjusting the height of the pair of squeeze rolls. By tightening double nuts relative to the bearing boxes, the rotation shaft of each squeeze roll can be adjusted to counter wear in the tapered surfaces of the rotation shaft or in the tapered rolls 37.

### BACKGROUND OF THE INVENTION

1. Field of the Invention

The present invention relates to a squeeze roll unit for curling a plate shaped member into a tube shape and heat welding both edges thereof using squeeze rolls.

2. Description of the Related Art

Conventionally, electro-resistance-welded tubes that are used for hot water supply tubes and cold water supply tubes or for heat exchange tubes in air conditioners or refrigerators or the like are formed into a tube shape by curling a plate shaped member into a rounded shape as it is being fed along. The plate shaped member in this case being a belt of metal formed from copper or brass or the like. A tube is then formed by continuously welding both edges of the tube shaped material as it is fed along using a welding means provided by a high frequency dielectric welder or a high frequency resistance welder or the like.

During welding, the two edges of a plate shaped member that has been curled into a C shape are heated by a high frequency induction welder or the like that includes, for example, a work coil such as an induction heating coil and a ferrite core so that joule heat is generated that is concentrated in the two edges. As the plate shaped member, which has been curled into a C shape, passes between a pair of squeeze rolls, the two heated edges are pressed and butted welded together so as to form a tube shape. The plate shaped member that has been curled into a C shape slides along the concave curved surface of the squeeze rolls and drives the squeeze rolls to rotate. At the same time, the C shape plate shaped member is curled into a tube shape conforming to the contour of the concave curved surface of the squeeze rolls and the two edges are then welded. Therefore, a load is applied to support members that support the rotation shaft of each squeeze roll.

As a result, as is shown in FIG. 6, for example, both side surfaces b and b of a support member a are held under pressure by pressing members c so as to prevent the squeeze roll d from shifting position. Moreover, if substantially semicircular concave curved surfaces e of the pair of squeeze rolls d shift upwards or downwards or to the left or right, problems may occur such as the welding of the electro-resistance-welded tube not being performed satisfactorily, or the shape of the tube being defective. Therefore, it is necessary to adjust the positions of the concave curved surfaces e so that they match each other in the vertical and transverse directions so that the pair of substantially semicircular concave curved surfaces e of the squeeze rolls form a single substantially circular concave curved surface in order to form the C shape plate shaped member into an electro-resistance-welded tube.

However, because the two side surfaces b and b of the support member a form a vertical surface that is substantially orthogonal to the top and bottom surfaces, when they become worn over time due to the load from the moving plate shaped member a gap is created between them and the pressing members c, and the problem arises that the squeeze rolls d and d cannot be supported while being held a predetermined distance apart.

Moreover, when the rotation shaft of a squeeze roll d is supported by the support member a, because a structure is employed in which bearings are provided in the radial direction and in the thrust direction and the rotation shaft is rotatably supported, if the radial bearing and the thrust bearing are not each set with an approximately equal load, the pair of squeeze rolls are not driven to rotate uniformly which has given rise to the concern that this will hinder the heat welding of the electro-resistance-welded tube. In addition, it is necessary for the pair of squeeze rolls to be positioned in the vertical and transverse directions such that a single substantially circular concave curved surface is formed by the pair of substantially semicircular concave curved surfaces, however, the problem exists that over time the rotation shafts and bearings and the like of the squeeze rolls d tend to become worn and cause the positions of the squeeze rolls to shift, in which case it has proven difficult to adjust the positions of the squeeze rolls.

The present invention was achieved in view of the above circumstances and it is an object thereof to provide a squeeze roll unit for an electro-resistance-welded tube in which shifts in the position of the squeeze rolls can be prevented.

### SUMMARY OF THE INVENTION

The squeeze roll unit for an electro-resistance-welded tube according to the present invention is a squeeze roll unit for an electro-resistance-welded tube that is formed by curling a moving plate shaped member into a tube shape, passing the plate shaped member between a pair of squeeze rolls and heat welding both edges, wherein a side surface of a holding member that rotatably supports a rotation shaft to which each squeeze roll is fixed is formed in a tapered configuration, and the side surface of the holding member is fixed by being pressed by a pressing member.

When a plate shaped member is heat welded in a tube shape by squeeze rolls while being transported, the moving plate shaped member that has been curled into a C shape causes the respective concave curved surfaces of the pair of squeeze rolls to be driven to rotate by sliding against them and is then curled into a tube shape and welded. At this time, a load is applied to the squeeze rolls and a side surface of the holding member slides against the pressing member and is thus abraded, however, in this case as well, because the side surface of the holding member is formed in a tapered configuration, by fixing the pressing member by pressing it, both side portions can be reliably fixed under pressure by the pressing member and the pressing member can be reliably held and fixed.

Note that the abutting surfaces of the pressing member that abut against the side surfaces of the holding member may also be formed in a tapered configuration so as to be in surface contact with the side surfaces of the holding member.

It is also possible for a replaceable spacer to be provided below a bottom portion of each squeeze roll for adjusting the height of the squeeze roll.

By selectively fitting one of a plurality of types of spacer having different thicknesses and thereby matching together the heights of the respective concave curved surfaces of the pair of squeeze rolls, adjustments can be made to form a substantially circular concave curved surface in order to form an electro-resistance-welded tube having a high degree of circularity over the entirety thereof.

It is also possible for the rotation shaft of each squeeze roll to extend into the holding member and be rotatably supported via bearings that have tapered rolls that are inclined relative to the rotation shaft.

Because the bearings with tapered rolls have approximately the same holding strength in the horizontal direction and the vertical direction using only a single bearing, the rotation shaft of each squeeze roll can be rotatably supported in the thrust direction and in the radial direction.

It is also possible for the rotation shaft of each squeeze roll to be fixed below a bearing to the holding member by double nuts in a manner whereby the height of the rotation shaft can be adjusted.

The rotation shaft of each squeeze roll is firmly held by double nuts. Moreover, even if the tapered rolls of the bearings or the portions of the rotation shaft that are in contact with them become worn, by tightening the double nuts the holding strength of the rotation shaft can be ensured and the rotation shaft can be rotatably supported in the thrust direction and in the radial direction.

### BRIEF DESCRIPTION OF THE DRAWINGS

FIG. 1 is a schematic structural diagram showing a production line for an electro-resistance-welded tube manufacturing apparatus according to an embodiment of the present invention.

FIG. 2 is a plan view of the main portions showing a state in which an electro-resistance-welded tube is being welded by squeeze rolls.

FIG. 3 is a plan view of the main portions of a squeeze roll unit.

FIG. 4 is a vertical cross sectional view along the line A-A of the squeeze roll unit shown in FIG. 3.

FIG. 5 is a schematic side view showing a portion of the squeeze roll unit shown in FIG. 3 in a broken out view.

FIG. 6 is a schematic side view showing a portion of a conventional squeeze roll unit in a broken out view.

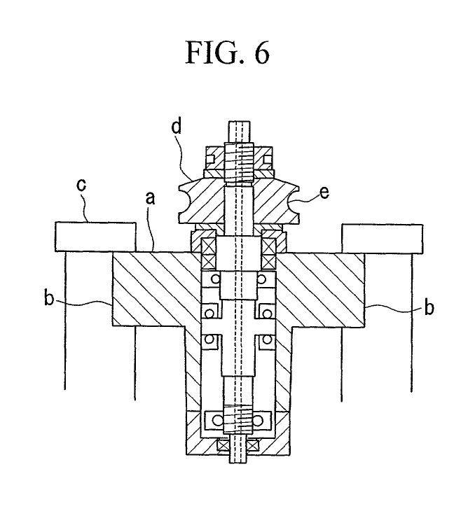

### DESCRIPTION OF THE PREFERRED EMBODIMENTS

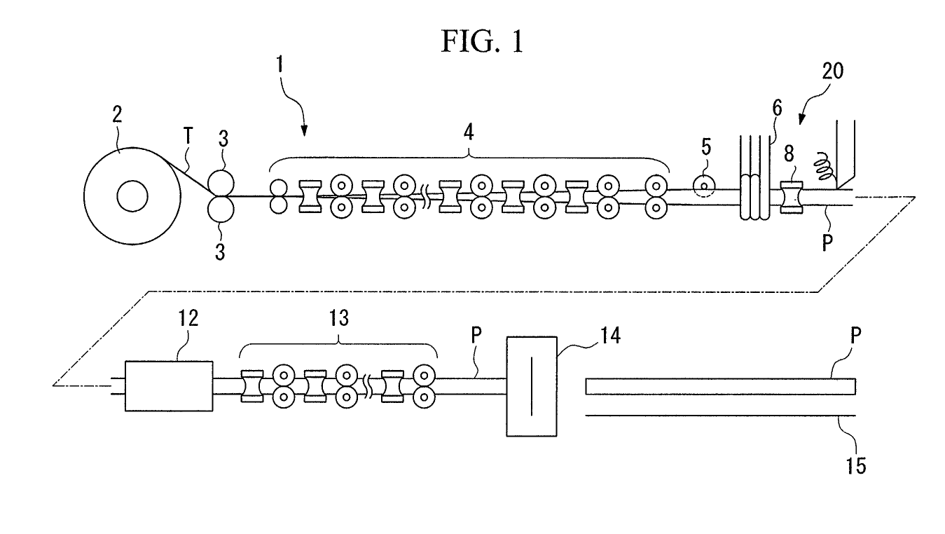

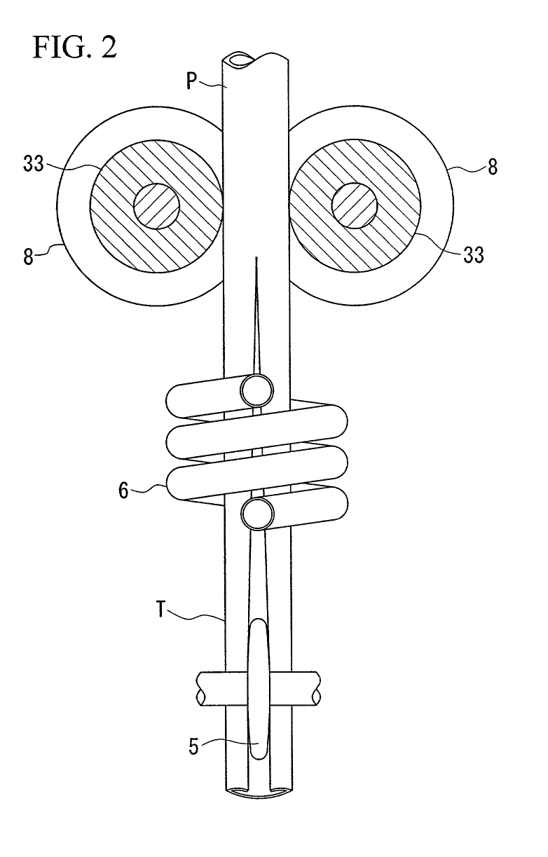

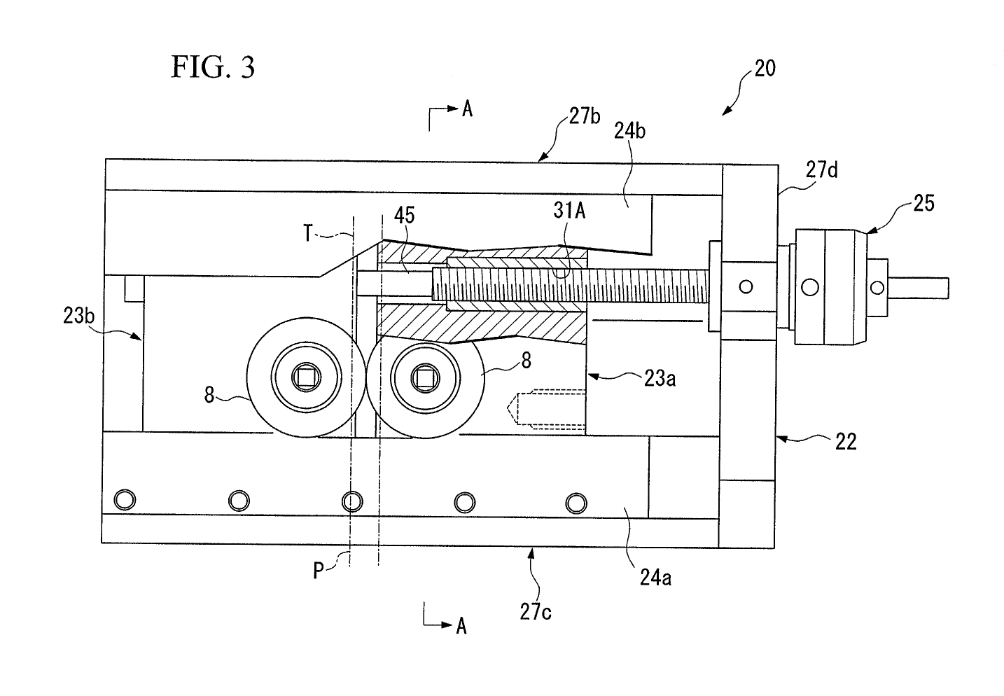

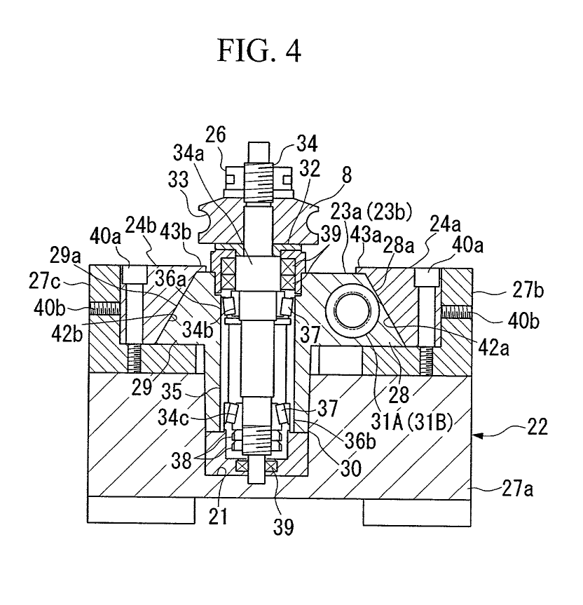

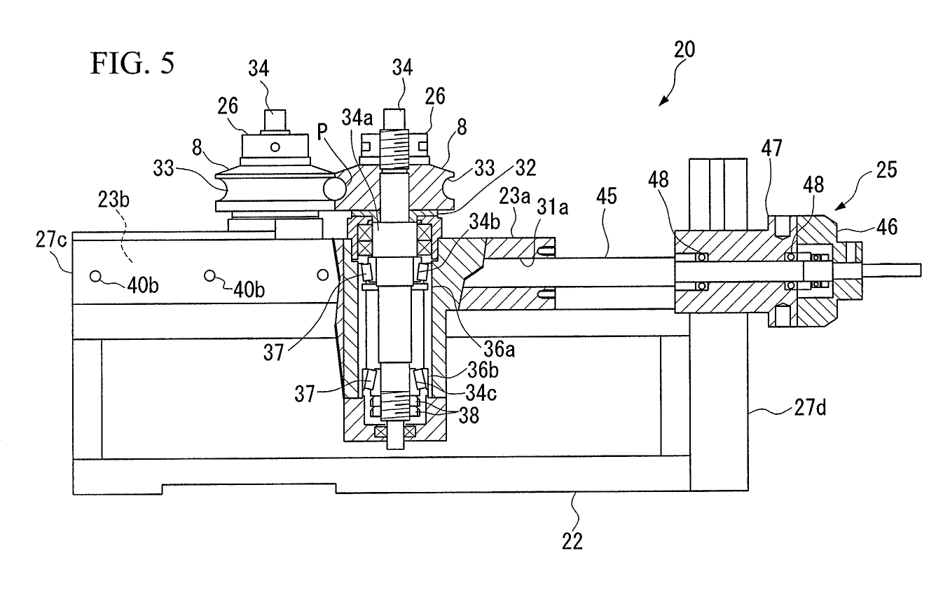

The squeeze roll unit according to an embodiment of the present invention will now be described with reference to FIGS. 1 through 5. FIG. 1 is a schematic structural diagram showing a production line for an electro-resistance-welded tube manufacturing apparatus; FIG. 2 is a schematic plan view showing a pair of squeeze rolls and an electro-resistance-welded tube in a welding section of the manufacturing apparatus shown in FIG. 1; FIG. 3 is a plan view of the main portions showing a portion of a supporting structure of a squeeze roll in a broken out view; FIG. 4 is a cross sectional view along the line A-A of the squeeze roll support structure shown in FIG. 3; and FIG. 5 is a side view showing a portion of the squeeze roll support structure shown in FIG. 3 in a broken out view.

The electro-resistance-welded tube according to the present embodiment is a simple metal tube having a smooth internal surface and is used as a hot water supply tube, a cold water supply tube, or the like, however, the present invention may also be applied to any metal tube such as a metal tube that has irregular structures formed on the external surface of the tube or that has grooves formed on the internal surface of the tube and is used in refrigerators or air-conditioning equipment. Moreover, the material from which the electro-resistance-welded tube according to the present embodiment is formed is brass, however, the present invention may also be applied to copper tubes, aluminum tubes, or metal tubes formed from some other material.

In the manufacturing apparatus 1 for manufacturing an electro-resistance-welded tube (referred to below simply as a “tube”) shown in FIG. 1, a plate shaped member T in the form of a continuous belt having a constant width that is formed from a belt of metal such as brass is continuously fed out from an uncoiler 2. The fed out plate shaped member T passes through a pair of pressing rolls 3 and then through a plurality of pairs of forming rolls 4 arranged in a row. The plate shaped member T is thus gradually rounded into the shape of a “C”. Once the amount of the gap between the two edges of the plate shaped member T that are to be butted together by a rolling separator 5 is made constant, the plate shaped member T is passed through a work coil of an induction heating section, for example, through an induction heating coil 6.

The induction heating coil 6 heats the plate shaped member T that has been rounded into a C shape and generates joule heat concentrated in both edges. When the plate shaped member T passes through a pair of squeeze rolls 8 and 8, as is shown in FIG. 2, the two heated edges are pressed and butt welded together. On the internal and external surfaces of the tube P formed by the welding of the plate shaped member T, internal and external surface beads are formed from fused material extruded from the welded portion. These are removed by cutting apparatuses.

After the tube P has passed through a cooling tank 12 and been forcibly cooled, it is shrunk to a predetermined external diameter by being passed through a plurality of pairs of sizing rolls 13 arranged in a row. After the tube P has been shaped by a shaping roll (not shown) it is cut into predetermined lengths, for example, 4 to 6 meters by a cutting apparatus 14 and the cut tubes are then stacked on a stock table 15.

A detailed description will now be given using FIGS. 3 through 5 of a squeeze roll unit 20 for supporting squeeze rolls 8 and 8 according to the present embodiment in the electro-resistance-welded tube manufacturing apparatus 1 having the above described schematic structure.

In FIGS. 3 through 5, the squeeze roll unit 20 is schematically formed by a base portion 22 in which is formed a groove portion 21 running in the direction in which the two squeeze rolls 8 and 8 are arranged; a pair of bearing boxes 23a and 23b (holding members) that each rotatably support the squeeze rolls 8 and 8 and that are held so as to be able to slide along the top of the base portion 22; side plates 24a and 24b (pressing members) that fix each bearing box 23a and 23b by pressing both sides thereof; and an adjustment member 25 that moves the pair of squeeze rolls 8 and 8 either towards or away from each other by sliding the pair of bearing boxes 23a and 23b in a direction either towards or away from each other.

As is shown in FIGS. 3 and 4, the base portion 22 is formed substantially in a box shape that is at least provided with a bottom portion 27a; a pair of side portions 27b and 27c, each having a substantially L shaped cross section, that are provided facing each other along both ends of the top surface of the bottom portion 27a; and an end portion 27d that stands upright also on the top surface of the bottom portion 27a substantially orthogonally to the side portions 27b and 27c. A groove portion 21 is formed in the bottom portion 27a extending in the direction in which the two side portions 27b and 27c extend. Namely, the groove portion 21 is formed along a direction that is substantially orthogonal to the direction in which the plate shaped member T is moved.

As is shown in FIG. 4, the bearing box 23a (or 23b) is formed with a substantially T shaped cross section having two wing portions 28 and 29 and a fitting portion 30. The fitting portion 30 fits in the groove portion 21 of the base portion 22 so as to be able to slide along the groove portion 21. Side surfaces 28a and 29a at both ends of the two wing portions 28 and 29 are each formed opposing each other in a tapered configuration in which the gap between the two side surfaces 28a and 29a gradually widens moving from the top portion to the bottom portion thereof. A penetrating screw hole 31A in which a female thread is cut running in the direction of the groove portion 21 is formed in one wing portion 28.

The other bearing box 23b has the same structure as the bearing box 23a (the same descriptive symbols are used for the same component portions and a description thereof is omitted), and in the same way a penetrating screw hole 31B in which a female thread is cut running in the direction of the groove portion 21 is formed in the one wing portion 28. The thread cut in the penetrating screw hole 31A screws in the reverse direction to that cut in the penetrating screw hole 31B and both penetrating screw holes are arranged on the same axis to form the same straight line.

Each squeeze roll 8 has a substantially disk shaped configuration with a considerable thickness, and a concave curved surface 33 having a substantially semicircular cross section is formed around the entire circumference of a side surface of the thick portion. By aligning the pair of squeeze rolls 8 and 8 in a horizontal direction running along the groove portion 21 of the base portion 22, the plate shaped member T is curled substantially into a tube shape between the two facing concave curved surfaces 33 and 33, and the tube P is formed by then welding the two edges thereof. A rotation shaft 34 is fixed through the center portion of each disk shaped squeeze roll 8.

A spacer 32 is removably fitted between an upper wide diameter portion 34a formed on the rotation shaft 34 and the squeeze roll 8. By replacing this spacer 32 as appropriate with one of a different thickness, it is possible to adjust the respective heights of the concave curved surfaces 33 and 33 between the pair of squeeze rolls 8. A nut 26 for fixing each squeeze roll 8 is screwed onto the rotation shaft 34 above the squeeze roll 8. When the height of the squeeze roll 8 is adjusted, the nut 26 simply needs to be refastened.

A through hole 35 is formed in the bearing box 23a extending from the top surface into the fitting portion 30. Bearings 36a and 36b are fitted into the top and bottom portions in the through hole 35. A plurality of tapered rolls 37 that are inclined at a predetermined angle relative to the direction in which the rotation shaft 34 extends are provided in each bearing 36a and 36b. The rotation shaft 34 of the squeeze roll 8 is rotatably supported by the bearings 36a and 36b as a result of the rotation shaft 34 being inserted via the bearings 36a and 36b into the through hole 35 and the respective tapered surfaces 34b and 34c of the rotation shaft 34 being placed in contact with the top and bottom tapered rolls 37.

Two nuts 38 and 38 are fastened to the bottom portion of the rotation shaft 34 that is protruding below the bottom bearing 36b inside the through hole 35, and work as a double nut to fix the rotation shaft 34 such that it can rotate relative to the bearings 36a and 36b. Oil seals 39 are also fitted between the rotation shaft 34 and the through hole 35 on the outer side of the top bearing 36a and on the outer side of the double nuts 38 and 38 so as to form a seal.

As a result, the rotation shaft 34 of the squeeze roll 8 is supported so as to be able to rotate in the radial direction and the thrust direction by the taper rolls 37 of the pair of bearings 36a and 36b. When the tapered rolls 37 and the tapered surfaces 34b and 34c of the rotation shaft 34 become worn with use over time, adjustments can be made by further tightening the double nuts 38 and 38 or replacing the spacer 32 or the like such that the rotation shaft 34 is rotatably supported by the bearings 36a and 36b provided with the tapered rolls 37.

Side plates 24a and 24b are mounted between the bearing boxes 23a and 23b and both side portions 27a and 27b of the base portion 22 and these side plates 24a and 24b fix side surfaces 28a and 29a of the two wing portions 28 and 29 of the bearing boxes 23a and 23b under pressure using bolts 40a and 40b. Abutting surfaces 42a and 42b of the respective side plates 24a and 24b are formed as tapered surfaces so as to press against the side surfaces 28a and 29a of the wing portions 28 and 29, and are in surface contact with the side surfaces 28a and 29a. The top ends of the abutting surfaces 42a and 42b are formed as flange portions 43a and 43b that anchor the top surfaces of the wing portions 28 and 29.

Next, in the adjustment member 25 an adjustment bolt 45 that penetrates an end portion 27d of the base portion 22 screws into the penetrating screw holes 31A and 31B in the two bearing boxes 23a and 23b that are arranged along the groove portion 21. The adjustment bolt 45 is provided with a head portion 46 serving as an operating portion on the opposite side of the end portion 27d from the bearing boxes 23a and 23b. A cylinder portion 47 into which the adjustment bolt 45 is inserted is fitted into the end portion 27d. Thrust bearings 48 and 48 that rotatably support the adjustment bolt 45 are provided at an internal surface of the cylinder portion 47.

As a result, by rotating the head portion 46 of the adjustment bolt 45 either clockwise or counterclockwise, the bearing boxes 23a and 23b are moved either in a direction in which they approach each other or in a direction in which they move away from each other along the groove portion 21 via the penetrating through holes 31A and 31B that are formed with screw threads that screw in the reverse direction to each other. Consequently, the squeeze rolls 8 and 8 supported respectively by the bearing boxes 23a and 23b are moved either towards each other or away from each other.

Accordingly, it is possible to install replacement squeeze rolls 8 having different dimensions in accordance with differences in the external diameter or thickness of the tube P being manufactured, and to adjust the gap between the squeeze rolls 8 and 8 as is appropriate using the adjustment member 25.

The squeeze roll unit 20 for an electro-resistance-welded tube P according to the present embodiment has the above described structure. In the manufacturing apparatus 1 for manufacturing an electro-resistance-welded tube P shown in FIG. 1, a plate shaped member T formed from brass, for example, is continuously fed out from an uncoiler 2. The fed out plate shaped member T passes through forming rolls 4 and is gradually rounded into the shape of a C. The plate shaped member T is then passed through the induction heating coil 6 of an induction heating section. When the plate shaped member T that has been heated by the induction heating coil 6 passes through the pair of squeeze rolls 8 and 8, the two heated edges are pressed and butt welded together.

The pair of squeeze rolls 8 and 8 arranged in the manner shown in FIGS. 3 and 5 form a substantially circular space through the concave curved surfaces 33 and 33 thereof and further curl the C shaped plate shaped member T into a rounded shape as they transport it along. They then heat weld both edges thereof so as to form the tube P. Therefore, because the C shaped plate shaped member T that is being transported slides while in contact with the concave curved surfaces 33, a load is applied to the squeeze rolls 8 and 8 and this load is transmitted to the bearing boxes 23a and 23b via the rotation shaft 34 and the bearings 36a and 36b.

Therefore, because the side surfaces 28a and 29a of the wing portions 28 and 29 of the bearing boxes 23a and 23b are in surface contact with the abutting surfaces 42a and 42b of the side plates 24a and 24b so as to receive the load, over time they become worn and a gap is formed causing rattling to occur. In this case as well, because the side surfaces 28a and 29a of the wing portions 28 and 29 and the abutting surfaces 42a and 42b of the side plates 24a and 24b are all formed as tapered surfaces, by further tightening the fastening bolts 40a and 40b in the horizontal and vertical directions of the side plates 24a and 24b, the side plates 24a and 24b are pressed against the side surfaces 28a and 29a of the wing portions 28 and 29 so that the rattling caused by wear is suppressed and it is possible to reliably fix the positions of the bearing boxes 23a and 23b.

Moreover, by providing the taper rolls 37 in the bearings 36a and 36b that rotatably support the rotation shaft 34 of each squeeze roll 8, the rotation shaft 34 can be supported in the thrust direction and in the radial direction. As a result, there is no need to provide bearings in both the thrust direction and the radial direction nor is there any need for separate bearings to be adjusted individually, thereby simplifying the adjustment process and reducing the number of parts. Even if the tapered rolls 37 and the tapered surfaces 34b and 34c of the rotation shaft 34 do become worn through the contact between the tapered surfaces 34b and 34c and the tapered rolls 37, by further tightening the double nuts 38 and 38 screwed onto the bottom portion of the rotation shaft 34, the rotation shaft 34 can be reliably supported in the thrust direction and radial direction while still being able to rotate.

Moreover, by swapping the spacer 32 between the upper wide diameter portion 34a of the rotation shaft 34 and the squeeze roll 8 for one having a different more appropriate thickness, the height of the concave curved surface 33 can be adjusted so that between the pair of squeeze rolls 8 and 8 the heights of the two concave curved surfaces 33 and 33 can be reliably adjusted so as to match each other. Furthermore, by rotating the adjustment bolt 45 so as to move the bearing boxes 23a and 23b either towards or away from each other via the penetrating screw holes 31A and 31B that have the opposite thread to each other, the squeeze rolls 8 and 8 are moved either towards or away from each other enabling the gap between the concave curved surfaces 33 and 33 to be adjusted.

Two bearings 36a and 36b for rotatably supporting the rotation shaft 34 are provided in the through hole 35, however, it is also possible for three or more or only one to be provided. Furthermore, it is not absolutely necessary for the abutting surfaces 42a and 42b of the side plates 27b and 27c that abut against the side surfaces 28a and 29a of the wing portions 28 and 29 of the bearing boxes 23a and 23b to be tapered surfaces, and it is sufficient if at least the side surfaces 28a and 29a of the wing portions 28 and 29 are formed in a tapered shape.

It is also possible for a separate nut or the like to be fitted onto the rotation shaft 34 instead of the upper wide diameter portion 34a that supports the squeeze roll 8 via the spacer 32 and for this to form the anchoring member for the spacer 32.

In the squeeze roll unit for an electro-resistance-welded tube according to the present invention, because the side surfaces of holding members that rotatably support a rotation shaft that is fixed to a squeeze roll are formed in a tapered configuration, and because side surfaces of the holding member are fixed under pressure by a pressing member, even if the side surfaces of the holding member are worn by being rubbed against the pressing member due to the load generated during the forming of the electro-resistance-welded tube, because the side surfaces are formed in a tapered configuration, by press fixing the pressing members, each side surface can be reliably fixed under pressure by a pressing member enabling the squeeze rolls to be reliably held and fixed.

Moreover, because a replaceable spacer for adjusting the height of the squeeze roll is provided below the squeeze roll, by selectively fitting one of a plurality of types of spacer having different thicknesses, the height of each concave curved surface of the pair of squeeze rolls can be adjusted so that they match each other enabling a high quality electro-resistance-welded tube to be manufactured.

Because the rotation shaft of the squeeze rolls extends into the holding member and is rotatably supported via bearings that have tapered rolls that are inclined relative to the rotation shaft, it is possible to support the rotation shaft in both the thrust and radial directions using a single type of bearing.

Further, because the rotation shaft of each squeeze roll is fixed below the bearing to the holding member by double nuts in a manner whereby the height thereof can be adjusted, not only can the rotation shaft be held firmly, but it is possible to rotatably support the rotation shaft by tightening the double nut even when the tapered rolls of the bearings become worn.

What is claimed is:

1. A squeeze roll unit for an electro-resistance-welded tube formed by curling a moving plate shaped member into a tube shape, passing the plate shaped member between a pair of squeeze rolls and heat welding both edges, wherein
a pair of side surfaces of a holding member that rotatably supports a rotation shaft to which each squeeze roll is fixed is formed in a tapered configuration, and the side surfaces of the holding member are fixed by being pressed by pressing members.

2. A squeeze roll unit according to claim 1, wherein a replaceable spacer is provided below a bottom portion of each squeeze roll for adjusting the height of the squeeze roll.

3. A squeeze roll unit according to claim 1, wherein the rotation shaft of each squeeze roll extends into the holding member and is rotatably supported via bearings that have tapered rolls that are inclined relative to the rotation shaft.

4. A squeeze roll unit according to claim 3, wherein the rotation shaft of each squeeze roll is fixed below a bearing to the holding member by double nuts in a manner whereby the height of the rotation shaft can be adjusted.
